(19) United States
(12) Patent Application Publication
(10) Pub. No.: US 2015/0268910 A1
(43) Pub. Date: Sep. 24, 2015

(54) IMAGE FORMING APPARATUS THAT PRINTS REPORT PAGE COINCIDING WITH PRINT JOB EXECUTION RESULT, CONTROL METHOD THEREFOR, AND STORAGE MEDIUM

(71) Applicant: CANON KABUSHIKI KAISHA, Tokyo (JP)

(72) Inventor: Yuzo Harano, Sagamihara-shi (JP)

(21) Appl. No.: 14/659,645

(22) Filed: Mar. 17, 2015

(30) Foreign Application Priority Data
Mar. 19, 2014 (JP) 2014-056230

(51) Int. Cl. G06F 3/12; H04N 1/00

(52) U.S. Cl. CPC G06F 3/1273; H04N 1/00005; H04N 1/00015; H04N 1/0005; H04N 1/00076; G06F 3/1259; H04N 2201/0082

(57) ABSTRACT

An image forming apparatus which is capable of making contents of a report page and execution results of a print job coincide with each other. Image data for printing is generated using job data on the print job, and first report page data is generated before execution of the print job based on attributes set in the print job. The generated image data is subjected to a printing process, and execution results of the printing process are obtained. When a content of the first report page data and the execution results do not coincide with each other, second report page data reflecting the execution results is regenerated and printed. When the content of the first report page data and the execution results coincide with each other, the first report page data is printed.

### BACKGROUND OF THE INVENTION

1. Field of the Invention

The present invention relates to an image forming apparatus, a control method therefor, and a storage medium.

2. Description of the Related Art

Conventionally, printing systems are equipped with functions of carrying out various processes as well as printing, and one of them is to print a result obtained by executing a print job as a report page with printed matter (see, for example, Japanese Laid-Open Patent Publication (Kokai) No. 2006-12011).

FIG. 8 is a view showing a report page according to a prior art.

Referring to FIG. 8, the report page is printed matter on which information such as various attributes of a received print job and execution results of the print job is expressed. For example, a title, a user name, and a print job name are shown on the report page in FIG. 8.

This report page is printed before or after execution of a print job, and on a printing site, is used for a wide variety of purposes and methods, for example, in checking attributes of the print job, checking printing results, issuing operational instructions for post-printing processes, or for use merely as a divider. One of purposes to print the report page is to visualize characteristics and attributes of a printed result so as to use them in post processing in a print workflow. Accordingly, information on the report page is required to be accurate and reliable.

However, according to the prior art, there may be cases where contents of a report page do not coincide with execution results obtained by actually performing printing. For example, on a report page for a print job for which stapling is designated, it is described that stapling has been performed. However, when stapling could not actually been performed due to, for example, the maximum number of printing sheets to be stapled being exceeded, printed matter has not actually been stapled together, and hence the contents of the report page and the execution result do not coincide with each other.

To explain the reason why contents of a report page and execution results do not coincide with each other, a description will now be given of an exemplary process according to a prior art up to printing of a report page.

FIG. 9 is a sequence diagram showing the procedure of a report page printing process according to a prior art.

Here, it is assumed, for example, that a client computer sends job data on a print job, and a print job processing unit and an image forming unit which an image forming apparatus having received the job data has carry out respective processes.

First, the client computer sends job data (step S801). In the image forming apparatus having obtained the job data, the print job processing unit performs image processing to generate print image data (step S802) and then generates report page data (step S803). The image forming unit then prints the print image data and performs post-processing (step S806) and then prints the report page data (step S807).

As shown in this sequence diagram, according to the prior art, report page data is generated before printing of print image data is completed.

One of the reasons why the print job processing unit generates report page data before the image forming unit completes printing of print image data is to exploit the full potential of productivity.

Specifically, the image forming apparatus spools a print job, performs RIP processing using a printer controller, forms an image using a printer engine, and performs post processing and sheet discharging using a finisher as concurrently as possible. Namely, to concurrently carry out the processes, report page data is generated before printing by the image forming unit is completed. Therefore, the prior art has the problem that contents of a report page and execution results do not coincide with each other.

### SUMMARY OF THE INVENTION

The present invention provides an image forming apparatus and a control method therefor, which are capable of making contents of a report page and execution results of a print job coincide with each other, as well as a storage medium.

Accordingly, a first aspect of the present invention provides an image forming apparatus comprising an image data generating unit configured to generate image data for printing using job data on a print job, a report page data generating unit configured to generate first report page data before executing the print job based on attributes set in the print job, a printing unit configured to carry out a printing process on the image data generated by the image data generating unit, an obtaining unit configured to obtain execution results of the printing process carried out by the printing unit, a determination unit configured to determine whether a content of the first report page data and the execution results coincide with each other, a report page data regenerating unit configured to, when the determination unit determines that the content of the first report page data and the execution results do not coincide with each other, regenerate second report page data reflecting the execution results, and a report printing unit configured to, when the determination unit determines that the content of the first report page data and the execution results do not coincide with each other, print the second report page data, and when the determination unit determines that the content of the first report page data and the execution results coincide with each other, print the first report page data.

Accordingly, a second aspect of the present invention provides an image forming apparatus comprising an image data generating unit configured to generate image data for printing using job data on a print job, a printing unit configured to carry out a printing process on the image data generated by the image data generating unit, an obtaining unit configured to obtain execution results of the printing process carried out by the printing unit, a report page data generating unit configured to, based on attributes set in the print job, generate report page data coinciding with the execution results obtained by the obtaining unit, and a report printing unit configured to print the report page data generated by the report page data generating unit.

Accordingly, a third aspect of the present invention provides an image forming apparatus comprising an image data generating unit configured to generate image data for printing using job data on a print job, a report page data generating unit configured to generate report page data before executing the print job based on attributes set in the print job, a printing unit configured to carry out a printing process on the image data generated by the image data generating unit, an obtaining unit configured to obtain execution results of the printing process carried out by the printing unit, a determination unit configured to determine whether a content of the report page data generated by the report page data generating unit and the execution results obtained by the obtaining unit coincide with each other, an alternative report page data obtaining unit configured to, when the determination unit determines that the content of the report page data and the execution results do not coincide with each other, obtain alternative report page data indicating that the content of the report page data and the execution results do not coincide with each other, and a report printing unit configured to, when the determination unit determines that the content of the report page data and the execution results do not coincide with each other, print the alternative report page data, and when the determination unit determines that the content of the report page data and the execution results coincide with each other, print the report page data.

Accordingly, a fourth aspect of the present invention provides a control method for an image forming apparatus, comprising an image data generating step of generating image data for printing using job data on a print job, a report page data generating step of generating first report page data before executing the print job based on attributes set in the print job;, a printing step of carrying out a printing process on the image data generated in the image data generating step, an obtaining step of obtaining execution results of the printing process carried out in the printing step, a determination step of determining whether a content of the first report page data and the execution results coincide with each other, a report page data regenerating step of, when it is determined in the determination step that the content of the first report page data and the execution results do not coincide with each other, regenerating second report page data reflecting the execution results, and a report printing step of, when it is determined in the determination step that the content of the first report page data and the execution results do not coincide with each other, printing the second report page data, and when it is determined in the determination step that the content of the first report page data and execution results coincide with each other, printing the first report page data.

Accordingly, a fifth aspect of the present invention provides a control method for an image forming apparatus, comprising an image data generating step of generating image data for printing using job data on a print job, a printing step of carrying out a printing process on the image data generated in the image data generating step, an obtaining step of obtaining execution results of the printing process carried out in the printing step, a report page data generating step of, based on attributes set in the print job, generating report page data coinciding with the execution results obtained in the obtaining step, and a report printing step of printing the report page data generated in the report page data generating unit.

Accordingly, a sixth aspect of the present invention provides a control method for an image forming apparatus, comprising an image data generating step of generating image data for printing using job data on a print job, a report page data generating step of generating report page data before executing the print job based on attributes set in the print job, a printing step of carrying out a printing process on the image data generated in the image data generating step, an obtaining step of obtaining execution results of the printing process carried out in the printing step, a determination step of determining whether a content of the report page data generated in the report page generating step and the execution results obtained in the obtaining step coincide with each other, an alternative report page data obtaining step of, when the it is determined in the determination step that the content of the report page data and the execution results do not coincide with each other, obtaining alternative report page data indicating that the content of the report page data and the execution results do not coincide with each other, and a report printing step of, when it is determined in the determination step that the content of the report page data and the execution results do not coincide with each other, printing the alternative report page data, and when it is determined in the determination step that the content of the report page data and the execution results coincide with each other, printing the report page data.

Accordingly, a seventh aspect of the present invention provides a non-transitory computer-readable storage medium storing a program for causing a computer to execute a control method for an image forming apparatus, the control method comprising, an image data generating step of generating image data for printing using job data on a print job, a report page data generating step of generating first report page data before executing the print job based on attributes set in the print job, a printing step of carrying out a printing process on the image data generated in the image data generating step, an obtaining step of obtaining execution results of the printing process carried out in the printing step, a determination step of determining whether a content of the first report page data and the execution results coincide with each other, a report page data regenerating step of, when it is determined in the determination step that the content of the first report page data and the execution results do not coincide with each other, regenerating second report page data reflecting the execution results, and a report printing step of, when it is determined in the determination step that the content of the first report page data and the execution results do not coincide with each other, printing the second report page data, and when it is determined in the determination step that the content of the first report page data and the execution results coincide with each other, printing the first report page data.

Accordingly, an eighth aspect of the present invention provides a non-transitory computer-readable storage medium storing a program for causing a computer to execute a control method for an image forming apparatus, the control method comprising an image data generating step of generating image data for printing using job data on a print job, a printing step of carrying out a printing process on the image data generated in the image data generating step, an obtaining step of obtaining execution results of the printing process carried out in the printing step, a report page data generating step of, based on attributes set in the print job, generating report page data coinciding with the execution results obtained in the obtaining step, and a report printing step of printing the report page data generated in the report page data generating unit.

Accordingly, a ninth aspect of the present invention provides a non-transitory computer-readable storage medium storing a program for causing a computer to execute a control method for an image forming apparatus, the control method comprising an image data generating step of generating image data for printing using job data on a print job, a report page data generating step of generating report page data before executing the print job based on attributes set in the print job, a printing step of carrying out a printing process on the image data generated in the image data generating step, an obtaining step of obtaining execution results of the printing process carried out in the printing step, a determination step of determining whether a content of the report page data generated in the report page generating step and the execution results obtained in the obtaining step coincide with each other, an alternative report page data obtaining step of, when the it is determined in the determination step that the content of the report page data and the execution results do not coincide with each other, obtaining alternative report page data indicating that the content of the first report page data and the execution results do not coincide with each other, and a report printing step of, when it is determined in the determination step that the content of the report page data and the execution results do not coincide with each other, printing the alternative report page data, and when it is determined in the determination step that the content of the report page data and the execution results coincide with each other, printing the report page data.

According to the present invention, when it is determined that contents of a report page represented by report page data generated in advance and execution results of processing on a print job do not coincide with each other, report page data reflecting the execution results is generated again. This makes contents of a report page and the execution results of the print job coincide with each other.

Further features of the present invention will become apparent from the following description of exemplary embodiments (with reference to the attached drawings).

### BRIEF DESCRIPTION OF THE DRAWINGS

FIG. 1 is a diagram schematically showing an arrangement of a printing system including a printing apparatus which is an image forming apparatus according to an embodiment of the present invention.

FIG. 2 is a view showing a conveyance path for a printing sheet in the printing apparatus in FIG. 1.

FIGS. 3A to 3C are flowcharts showing the procedure of printing processes which are carried out by a CPU in FIG. 1.

FIG. 4A is a flowchart showing the procedure of a print image data printing process in steps S103 and S202 in FIGS. 3A and 3B, and FIG. 4B is a flowchart showing the procedure of a report printing process in steps S107, S205, and S303 in FIGS. 3A to 3C.

FIGS. 5A to 5C are views showing report pages which are printed in a case where contents of a report page and execution results do not coincide with each other in the printing processes in FIGS. 3A to 3C.

FIG. 6 is a sequence diagram for the printing process A in FIG. 3A.

FIG. 7 is a sequence diagram for the printing process B in FIG. 3B.

FIG. 8 is a view showing a report page according to a prior art.

FIG. 9 is a view showing the procedure of a report page printing process according to a prior art.

### DESCRIPTION OF THE EMBODIMENTS

The present invention will now be described in detail with reference to the drawings showing an embodiment thereof.

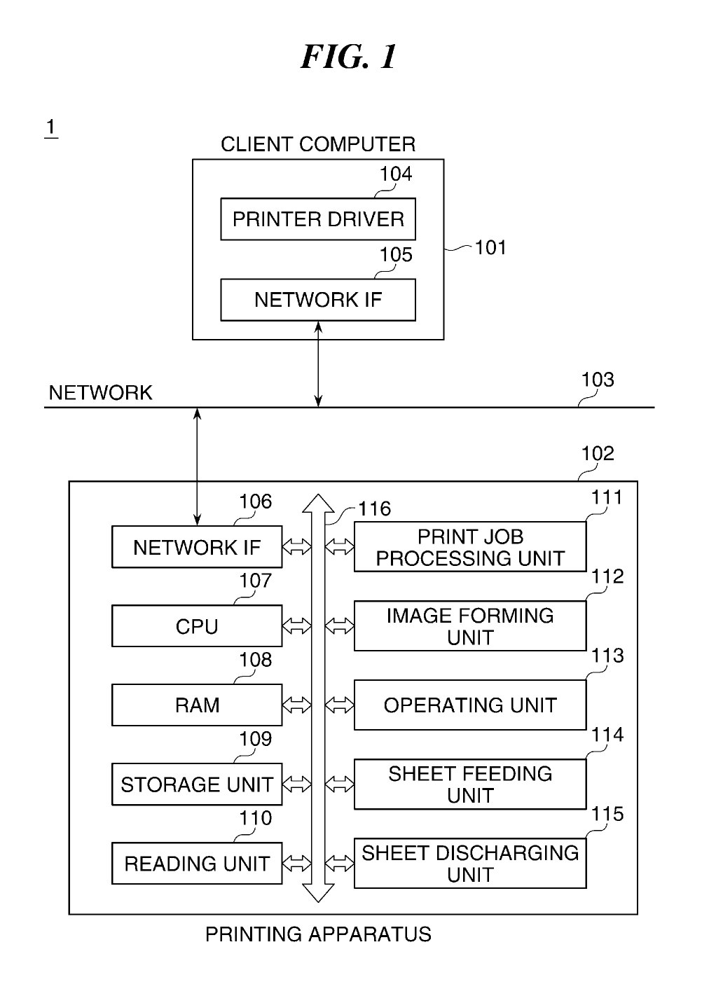

FIG. 1 is a diagram schematically showing an arrangement of a printing system 1 including a printing apparatus 102 which is an image forming apparatus according to an embodiment of the present invention.

Referring to FIG. 1, the printing system 1 is comprised of the printing apparatus 102 and a client computer 101, which are connected together via a network 103 and able to communicate with each other using a network protocol such as TCP/IP.

The client computer 101, which is a commonly-used personal computer, has a CPU, a ROM, a RAM (not shown), a printer driver 104, and a network interface 105.

The printer driver 104 is software running on an OS (operating system). The printer driver 104 expresses print data in PDL (page description language) in accordance with a printing instruction from an application and sends the print data as job data as well as attributes of a print job to the printing apparatus 102. The network interface 105 carries out a control process to communicate with external devices via the network 103.

Upon obtaining job data from the printer driver 104 of the client computer 101, the printing apparatus 102 is able to print an image represented by image data included in the job data and also print a report page. A report page according to the present embodiment shows various attributes of a print job, execution results of the print job, and so on (hereafter referred to as contents of a report page).

Next, a description will be given of an arrangement of the printing apparatus 102. The printing apparatus 102 has a network interface 106, a CPU 107, a RAM 108, a storage unit 109, a reading unit 110, a print job processing unit 111, an image forming unit 112, an operating unit 113, a sheet feeding unit 114, and a sheet discharging unit 115. These components are connected to one another via a system bus 116.

The network interface 106 carries out a control process to communicate with external devices via the network 103. The CPU 107 performs various types of arithmetic processing and information processing, device control, and so on using various programs stored in the storage unit 109 of the printing apparatus 102 and loaded into the RAM 108. Flowcharts which will be referred to later show the procedures of processes in which the CPU 107 executes programs loaded into the RAM 108.

The RAM 108, which is a type of commonly-used volatile storage device directly accessible from the CPU 107, is used as a work area for the CPU 107 and also used for other temporary data storage. The storage unit 109, which is an HDD according to the present embodiment, temporarily or permanently spools and stores job data on a print job received from the client computer 101.

The reading unit 110 optically reads an original. Specifically, the reading unit 110 has an original illumination lamp and a scanning mirror and optically scans an original placed on an original platen glass. Light reflected from the original is guided to a lens by the scanning mirror and a reflective mirror, and a light signal having passed through the lens is guided to a solid-state image pickup device. The light signal is converted into an electric signal by the solid-state image pickup device and recognized as an image signal. It should be noted that the solid-state image pickup device means, for example, an image sensor using a CCD (charge-coupled device) or a CMOS (complementary metal oxide semiconductor).

The print job processing unit 111 executes print jobs such as copy, PDL, and FAX to generate print image data and transfers the generated print image data to the image forming unit 112. It should be noted that a page description language means a language typified by a PS (PostScript) and PCL (printer control language and describing commands for controlling a page printer.

Upon receiving job data, the print job processing unit 111 subjects the job data to image processing such as RIP (raster image processor) processing according to print attributes of the job data and rasterizes the job data on a page-by-page basis to generate print image data.

The image forming unit 112 prints print image data sent from the print job processing unit 111. The image forming unit 112 according to the present embodiment performs printing using an electrophotographic method but may use an inkjet method or any other method.

The operating unit 113 is a user interface for use in, for example, performing operation and configuring settings on the printing apparatus 102, and in the present embodiment, is a device using an LCD (liquid crystal display) touch panel.

The sheet feeding unit 114 is a cassette, a deck, or the like housing printing sheets for use in the printing apparatus 102, and in general, a plurality of sheet feeding units is provided in the printing apparatus 102. Which one among the plurality of sheet feeding units feeds a printing sheet varies according to sheet attributes of a print job or settings or status of the printing apparatus 102 and is determined by the print job processing unit 111. A fed printing sheet eventually becomes printed matter in the image forming unit 112.

The sheet discharging unit 115 performs post-processing on printed matter, which has been generated by the image forming unit 112, according to attributes of a print job and discharges from the printing apparatus 102. The sheet discharging unit 115 has post-processing functions such as a stapling function, a punching function, a folding function, and a bookbinding function. Further, the sheet discharging unit 115 also has some discharged sheet destinations such as stack trays, and a post-processing function and a discharged sheet destination are determined according to attributes of a print job. The print job processing unit 111 provides post-processing control and sheet discharge control based on the determined post-processing function and discharged sheet destination.

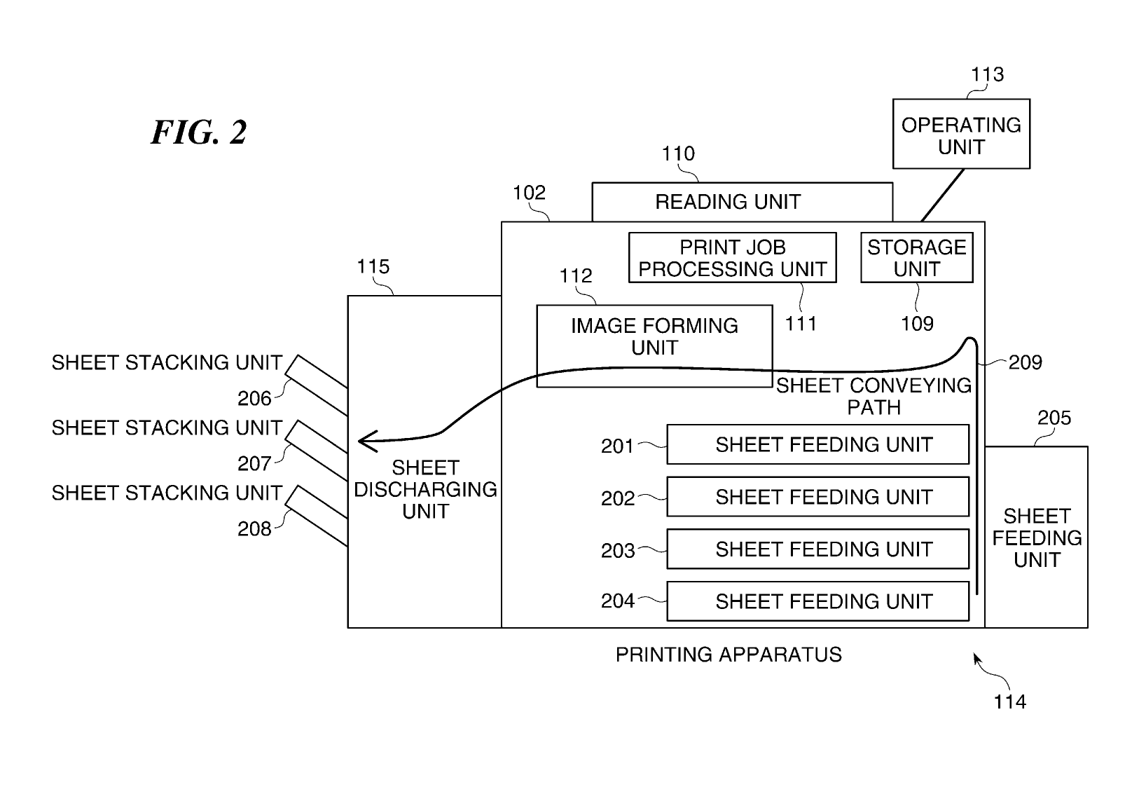

FIG. 2 is a view showing a conveyance path for a printing sheet in the printing apparatus 102 in FIG. 1.

In the following description referring to FIG. 2, description of components designated by the reference numerals already used in FIG. 1 is omitted.

Referring to FIG. 2, a printing sheet is fed from any one of the sheet feeding units 201, 202, 203, 204, and 205. While being conveyed on a sheet conveying path 209 indicated by an arrow, the fed printing sheet is subjected to printing by the image forming unit 112 and discharged to any one of stacking units 206, 207, and 208 by the sheet discharging unit 115.

A description will now be given of three types of printing processes which are carried out so as to make contents of a report page and execution results of a print job coincide with each other.

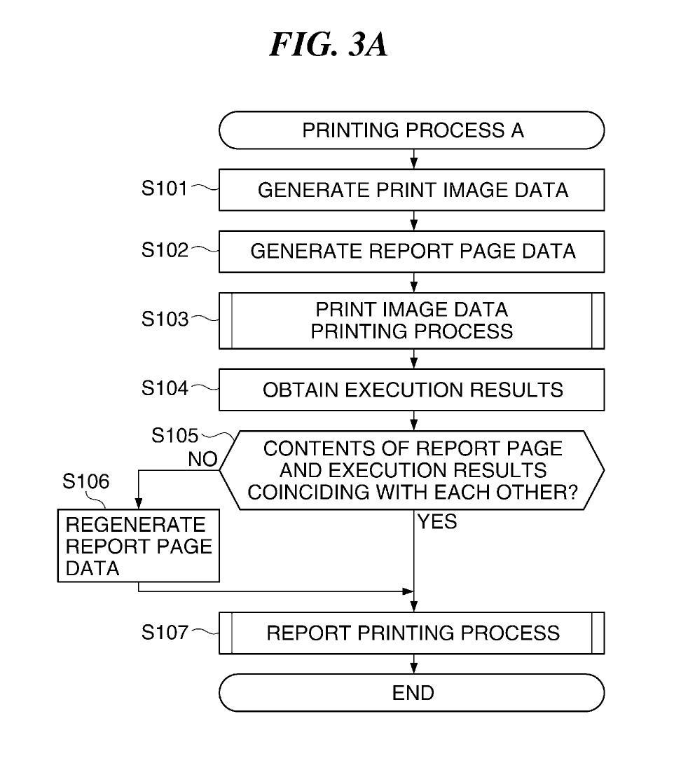

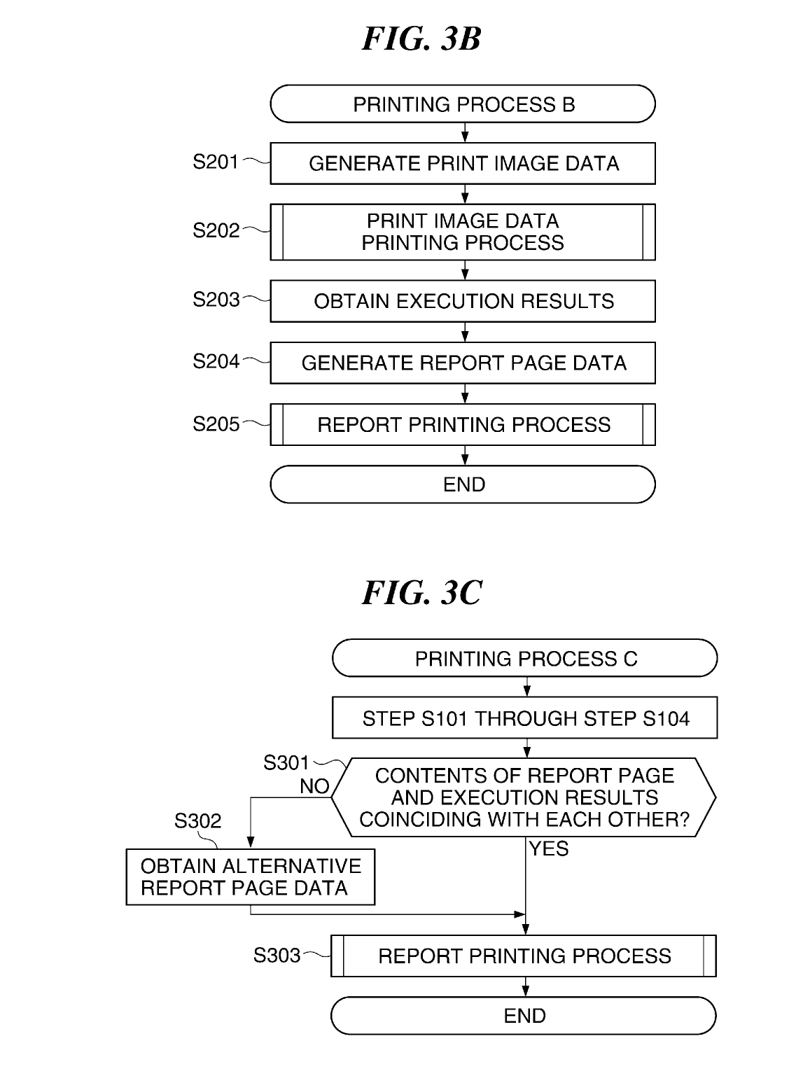

FIGS. 3A to 3C are flowcharts showing the procedures of printing processes which are carried out by the CPU 107 in FIG. 1.

FIGS. 3A, 3B, and 3C show three types of printing processes A, B, and C, respectively. These printing processes are common in that execution results of a print job are obtained, and then a report page is printed. Since a report page reflecting an obtained execution result is thus printed, the problem that contents of a report page and execution results of a print job do not coincide with each other is solved. The printing processes will now be described step by step.

FIG. 3A is a flowchart showing the procedure of the printing process A which is carried out by the CPU 107 in FIG. 1.

Referring to FIG. 3A, the print job processing unit 111 generates print image data (step S101). Specifically, in the step S101, the print job processing unit 111 obtains job data on a print job and temporarily spools the obtained job data in the storage unit 109. The print job processing unit 111 then analyzes the job data to obtain information such as a type of the print job and print settings, performs RIP processing on image data included in the job data, and then generates print image data (print image data generating unit).

The print job processing unit 111 then generates report page data from various attributes indicated in the job data and the result of the image processing on the image data (step S102: report page data generating unit). The generated print image data and report page data are transferred to the image forming unit 112.

The image forming unit 112 having received the print image data and the report page data carries out a print image data printing process (step S103: printing unit). In the step S103, a post process and a sheet discharging process are carried out by the sheet discharging unit 115 in addition to the printing process by the image forming unit 112.

The print job processing unit 111 then obtains execution results of the print image data printing process by the image forming unit 112 and execution results of the post process and the sheet discharging process by the sheet discharging unit 115 based on the print job (step S104: obtaining unit).

The print job processing unit 111 uses the obtained execution results to determine whether or not the contents of a report page represented by the report page data generated in the step S102 and the execution results coincide with each other (step S105: determination unit).

As a result of the determination in the step S105, when the contents of the report page and the execution results coincide with each other (YES in the step S105), the image forming unit 112 carries out a report printing process in which it prints the report page data generated in the step S102 (step S107), and terminates the present process.

On the other hand, as a result of the determination in the step S105, when the contents of the report page and the execution results do not coincide with each other (NO in the step S105), the print job processing unit 111 regenerates report page data coinciding with the execution results (step S106: report page data regenerating unit). The image forming unit 112 carries out a report printing process in which it prints the report page data regenerated in the step S106 (step S107: report printing unit), and terminates the present process.

FIG. 3B is a flowchart showing the procedure of the printing process B which is carried out by the CPU 107 in FIG. 1.

Referring to FIG. 3B, the print job processing unit 111 generates print image data as in the step S101 described above (step S201). The generated print image data is transferred to the image forming unit 112. Then, as in the step S103, the image forming unit 112 carries out a print image data printing process (step S202). Then, as in the step S104, the print job processing unit 111 obtains execution results of the print image data printing process (step S203).

Then, based on various attributes indicated in job data and results of image processing on image data, the print job processing unit 111 generates report page data coinciding with the execution results obtained in the step S203 (step S204: report page data generating unit). The generated report page data is transferred to the image forming unit 112.

The image forming unit 112 then carries out a report printing process in which it prints the report page data generated in the step S204 (step S205: report printing unit), and terminates the present process.

FIG. 3C is a flowchart showing the procedure of the printing process C which is carried out by the CPU 107 in FIG. 1.

Referring to FIG. 3C, first, the processes in the steps S101 to S104 described above are carried out.

The print job processing unit 111 uses execution results of a print image data printing process, post process, and sheet discharging process on the print image data obtained in the step S104 to determine whether or not the contents of a report page represented by report page data generated in the step S102 and the execution results coincide with each other (step S301).

As a result of the determination in the step S301, when the contents of the report page and the execution results coincide with each other (YES in the step S301), the image forming unit 112 carries out a report printing process in which it prints the report page data generated in the step S102 (step S303), and terminates the present process.

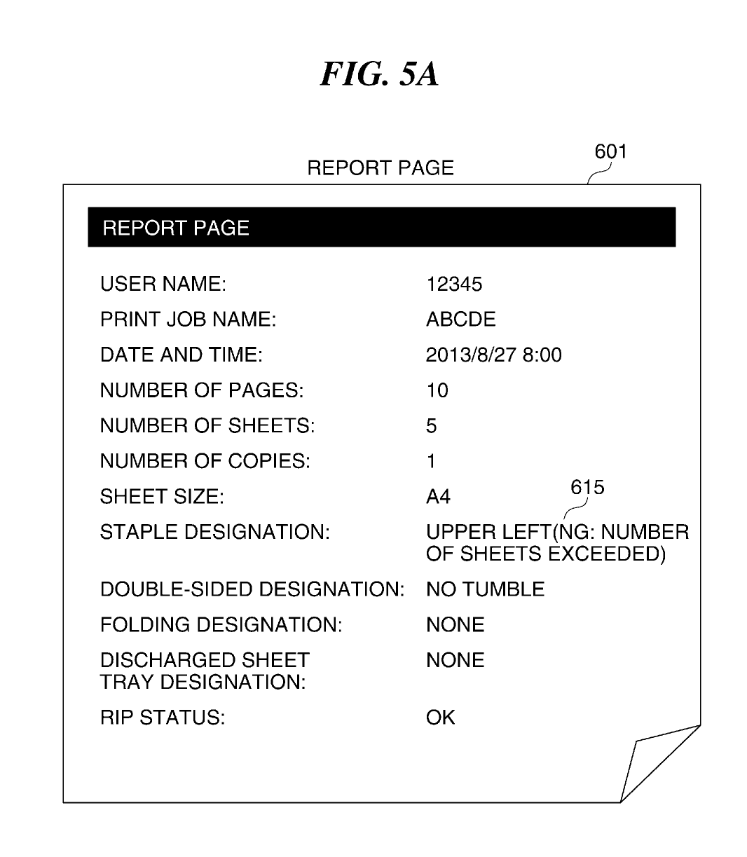

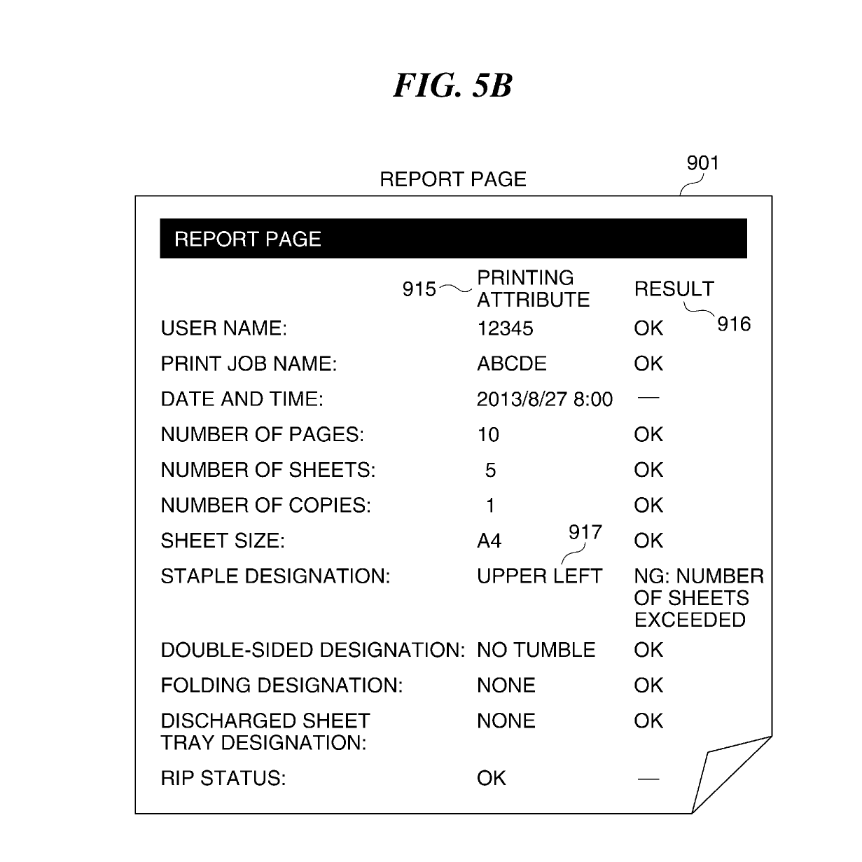

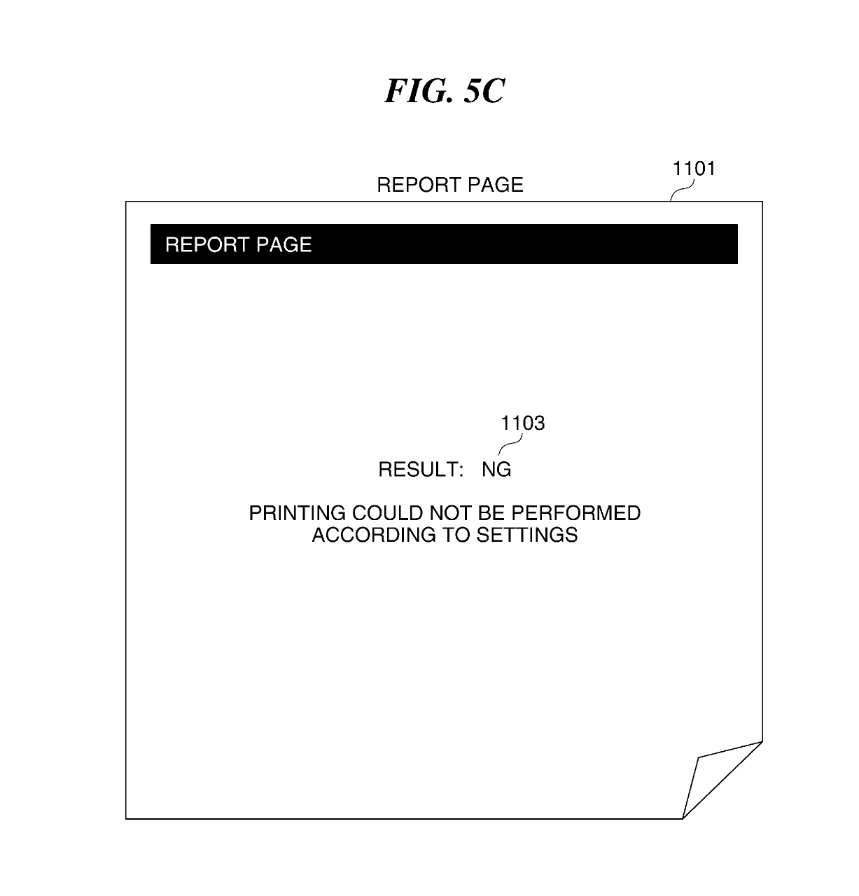

On the other hand, as a result of the determination in the step S301, when the print job processing unit 111 determines that the contents of the report page and the execution results do not coincide with each other (NO in the step S301), the process proceeds to step S302. In the step S302, the print job processing unit 111 obtains alternative report page data which represents a universal alternative repot page which will be described later with reference to FIG. 5C from the storage unit 109 (step S302: an alternative report page data obtaining unit). The obtained alternative report page data is transferred to the image forming unit 112.

The image forming unit 112 carries out a report printing process in which it prints the alternative report page data generated in the step S302 (step S303: report printing unit), and terminates the present process.

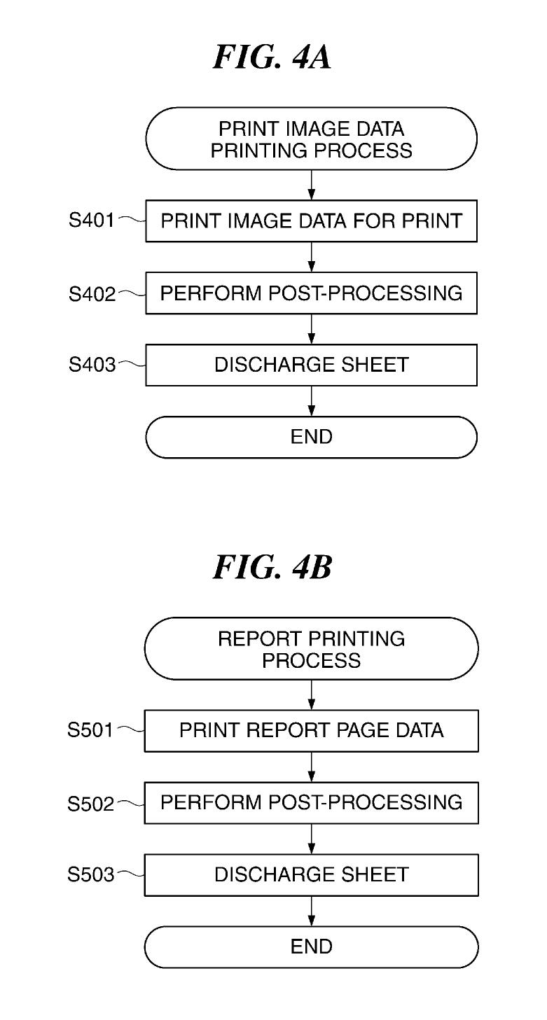

FIG. 4A is a flowchart showing the procedure of the print image data printing process in the steps S103 and S202 in FIGS. 3A and 3B.

Referring to FIG. 4A, in response to an instruction to print print image data from the print job processing unit 111, the image forming unit 112 prints the print image data on a printing sheet (step S401).

The print job processing unit 111 then conveys the printing sheet with the print image data printed thereon to the sheet discharging unit 115 and issues an instruction to carry out a post process designated in attributes of a print job. The sheet discharging unit 115 carries out the post process on the printing sheet in accordance with the instruction from the print job processing unit 111 (step S402).

The print job processing unit 111 then issues an instruction to discharge the printing sheet, which has been subjected to the post process, as final printed matter to any one of the stacking units 206, 207, and 208. As a result, the sheet discharging unit 115 discharges the printed matter to any of the stacking units 206, 207, and 208 (step S403). The present process is then terminated.

FIG. 4B is a flowchart showing the procedure of the report printing process in the steps S107, S205, and S303 in FIGS. 3A to 3C.

Referring to FIG. 4B, the image forming unit 112 having been instructed to print report page data by the print job processing unit 111 prints the report page data on a printing sheet (step S501). It should be noted that in the printing process C in FIG. 3C, alternative report page data is printed in place of the report page data.

The print job processing unit 111 then conveys the printing sheet with the report page data printed thereon to the sheet discharging unit 115 and issues an instruction to carry out a post process designated in attributes of a print job. The sheet discharging unit 115 carries out the post process on the printing sheet in accordance with the instruction from the print job processing unit 111 (step S502).

The print job processing unit 111 then issues an instruction to discharge the printing sheet, which has been subjected to the post process, as final printed matter to any one of the stacking units 206, 207, and 208. As a result, the sheet discharging unit 115 discharges the printed matter to any one of the stacking units 206, 207, and 208 (step S503). The present process is then terminated.

FIGS. 5A to 5C are views showing report pages printed in a case where contents of a report page and execution results do not coincide with each other in the printing processes in FIGS. 3A to 3C.

FIG. 5A is a view showing a report page 601 printed in the printing process A or the printing process B in FIGS. 3A and 3B.

As described above, a report page shows various attributes of a print job, result of a printing process, and so on, and a title (“Report Page”), a user name, a print job name, and so on are printed on the report page 601 in FIG. 5A.

The report page 601 is a print of report page data regenerated in the step S106 in FIG. 3A when contents of the report page and execution results do not coincide with each other. For this reason, the report page 601 shows a difference between contents of the report page represented by the repot page data generated in the step S102 in FIG. 3A and execution results as well as a cause for the difference.

Specifically, the report page 601 shows that although stapling was designated in a print job, the number of sheets used in the print job exceeded the maximum number of printing sheets to be stapled, and hence the stapling process was not be carried out.

Namely, a stapling designation field 615 shows “NG” which indicates that although stapling at the upper left corners of printing sheets is designated, there is a difference between contents of the report page and execution results, and “the number of sheets exceeded” which is a cause for this difference. “The number of sheets exceeded” indicates that the number of sheets used in a print job exceeded the maximum number of printing sheets to be stapled.

FIG. 5B is a view showing a report page 901 printed in the printing process A or the printing process B in FIGS. 3A and 3B.

A title (“Report Page”), a user name, a print job name, and so on are printed on the report page 901 in FIG. 5B.

As distinct from the report page 601 in FIG. 5A, results 916 as well as print attributes 915, which are for indicating various attributes of a print job and results of image processing, are printed the report page 901 in FIG. 5B. As the results 916, “OK” is written when there is no difference between a content of a report page and an execution result, and “NG” is written when there is a difference between a content of a report page and an execution result. When the result 916 for the print attribute 915 cannot be expressed, and when there is no need to clearly specify the print attribute 915, the result 916 may be expressed as “−”.

As with the case shown in FIG. 5A, the report page 901 shows that stapling could not be performed because the number of sheets used in a print job exceeded the maximum number of printing sheets to be stapled.

In this case, stapling at the upper left corners of printing sheets is designated, and hence “Upper Left” is printed as the printing attribute 915 in a stapling designation field 917. As the result 916 in the stapling designation field 917, “NG” indicating that there is a difference between a content of a report page and execution results, and “the number of sheets exceeded” which is a cause for the difference are printed.

According to the report page 901 in FIG. 5B, printing attributes and printing results for the printing attributes are visualized in detail, and this improves the accuracy and reliability of information expressed by a report page.

FIG. 5C is a view showing an alternative report page 1101 printed in the printing process C in FIG. 3C.

A title (“Report Page”) and a printing result 1103 are shown on the report page 1101 in FIG. 5C.

The printing result 1103 on the alternative report page 1101 shows that contents of a report page and execution results do not coincide with each other, and does not include any information different from at least execution results of a print job. For example, in the example shown in FIG. 5C, “NG” “Printing according to settings could not be performed” is printed as the printing result 1103, and the printing result 103 does not include any information different from at least execution results of a print job.

This prevents incorrect information from being offered as a report page to an operator of the printing apparatus 102.

When the report page in FIG. 5C is used, the process to generate again report page data reflecting execution results is not required, and hence report page data is quickly printed.

Among the report pages described above, the report pages 601 and 901 in FIGS. 5A and 5B show a plurality of items as attributes of a print job. Specifically, a title, a use name, a user name, a print job name, a date and time, the number of pages, the number of pages, the number of copies, the sheet size, stapling designation, double-sided designation, folding designation, discharged sheet tray designation, and a RIP status are shown. However, various attributes of a print job printed on a report page should not be limited to them.

The title in FIGS. 5A to 5C is “Report Page”. However, the title should not be limited to “Report Page” because it is called a cover page, a status print, a banner page, or the like according to whether it is printed before or after print image data is printed, the purpose of use, or the like.

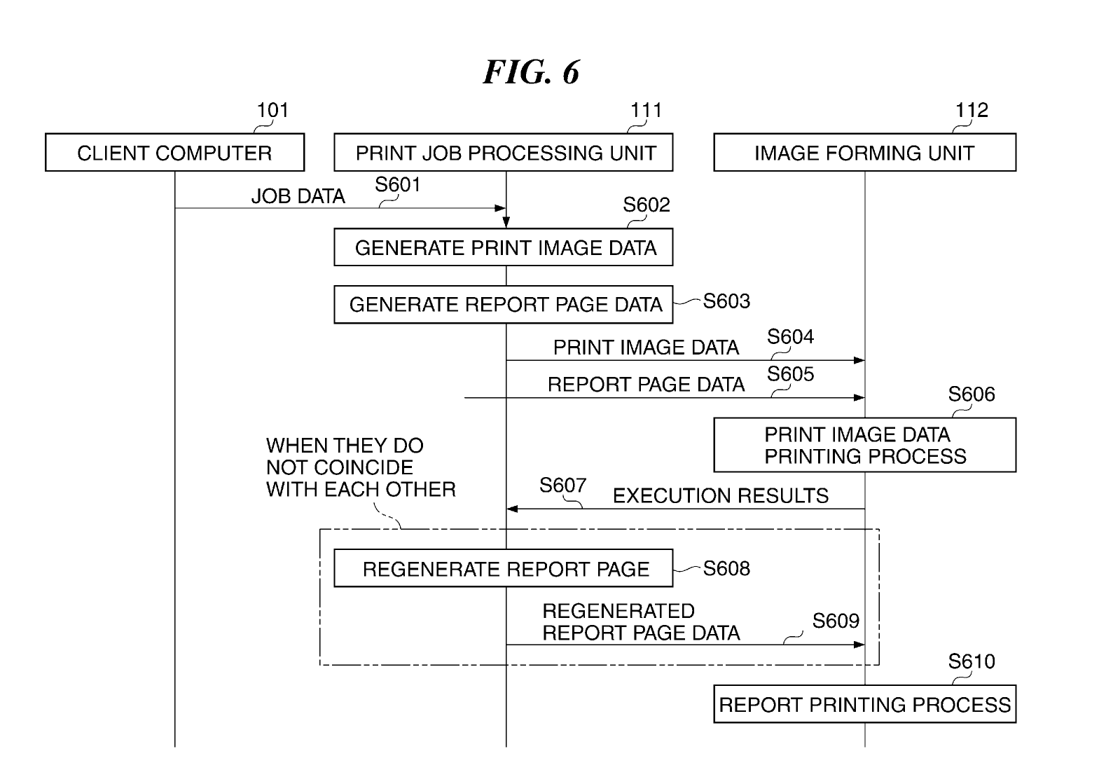

FIG. 6 is a sequence diagram for the printing process A in FIG. 3A in the client computer 101 and the print job processing unit 111 and the image forming unit 112 in the printing apparatus 102 in FIG. 1.

Referring to FIG. 6, the client computer 101 sends job data to the printing apparatus 102 (step S601), and when the printing apparatus 102 obtains the job data, the print job processing unit 111 generates print image data from the job data (step S602).

The print job processing unit 111 then generates report page data from various attributes indicated in the job data and results of the image processing on image data (step S603). The generated print image data and report page data are transferred to the image forming unit 112 (steps S604 and S605).

The image forming unit 112 having been received the print image data and the report page data carries out a print image data printing process (step S 606). The image forming unit 112 then sends execution results of the printing process by the image forming unit 112 and the execution results of the post process and the sheet discharging process by the sheet discharging unit 115 based on attributes in the print job to the print job processing unit (step S607). The print job processing unit obtains the execution results.

The print job processing unit 111 uses the obtained execution results to determine whether or not contents of a report page represented by the report page data generated in the step S603 and the execution results coincide with each other.

When the contents of the report page and the execution results coincide with each other, the image forming unit 112 carries out a report printing process in which it prints the report page data generated in the step S603 (step S610), and terminates the present process.

On the other hand, when the contents of the report page and the execution results do not coincide with each other, the print job processing unit 111 regenerates report page data coinciding with the execution results (step S608) and transfers the regenerated report page data to the image forming unit 112 (step S609). The image forming unit 112 carries out a report printing process in which it prints the report page data regenerated in the step S608 (step S610), and terminates the present process.

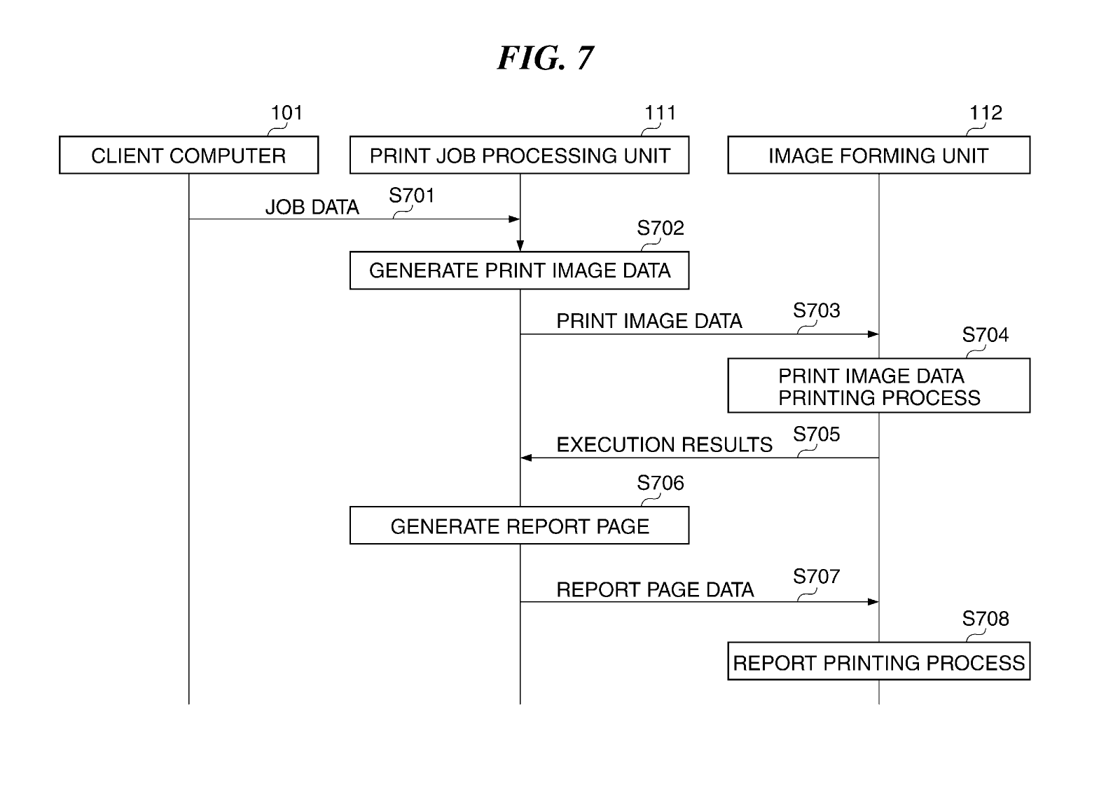

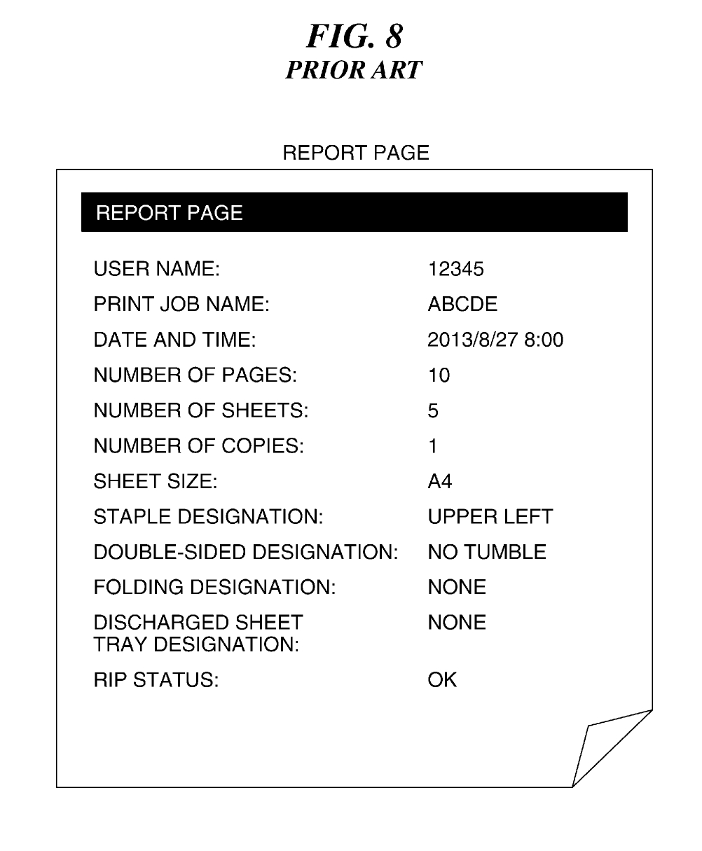

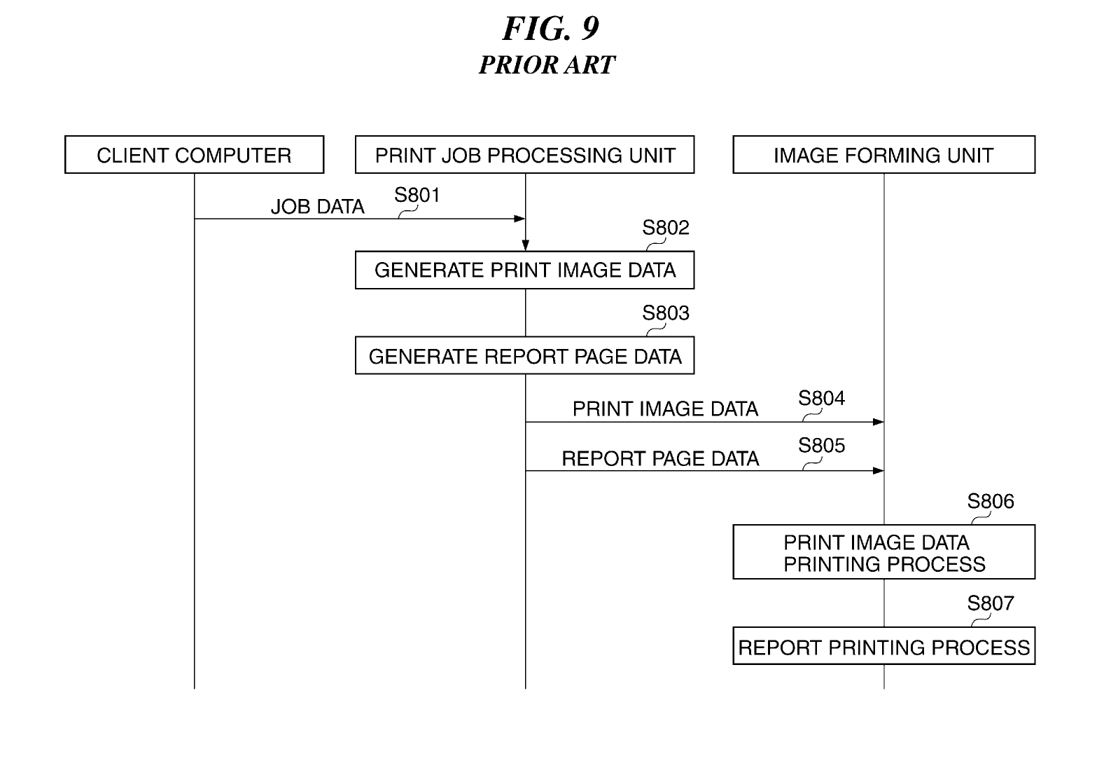

FIG. 7 is a sequence diagram for the printing process B in FIG. 3B in the client computer 101 and the print job processing unit 111 and the image forming unit 112 in the printing apparatus 102 in FIG. 1.

Referring to FIG. 7, the client computer 101 sends job data to the printing apparatus 102 (step S701), and when the printing apparatus 102 obtains the job data, the print job processing unit 111 generates print image data from the job data (step S702). The generated print image data is transferred to the image forming unit 112 (step S703).

The image forming unit 112 carries out a print image data printing process in which it prints the print image data. The image forming unit 112 then sends execution results of a printing process by the image forming unit 112 and a post process and a sheet discharging process by the sheet discharging unit 115 based on attributes of a print job to the print job processing unit 111 (step S705), and the print job processing unit 111 obtains the execution results.

The print job processing unit 111 then generates report page data from various attributes indicated in the job data obtained in the step S701, results of image processing on image data, and the execution results obtained in the step S705 (step S706). The generated report page data is transferred to the image forming unit 112 (steps S707).

The image forming unit 112 having received the report page data generated in the step S706 carries out a report printing process in which it prints the report page data (step S708), and terminates the present process.

As described above, according to the present embodiment, report page data is generated in advance (the step S102 in FIG. 3), and execution results showing results of a printing process are obtained (the step S104). When it is then determined that contents of a report page represented by the report page data generated in advance and the execution results do not coincide with each other (NO in the step S105), report page data reflecting the execution results is printed (the steps 5106 and S107). This makes the contents of the report page and the execution results coincide with each other.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-056230, filed Mar. 19, 2014, which is hereby incorporated by reference herein in its entirety.

What is claimed is:

1. An image forming apparatus comprising:
an image data generating unit configured to generate image data for printing using job data on a print job;
a report page data generating unit configured to generate first report page data before executing the print job based on attributes set in the print job;
a printing unit configured to carry out a printing process on the image data generated by said image data generating unit;
an obtaining unit configured to obtain execution results of the printing process carried out by said printing unit;
a determination unit configured to determine whether a content of the first report page data and the execution results coincide with each other;
a report page data regenerating unit configured to, when said determination unit determines that the content of the first report page data and the execution results do not coincide with each other, regenerate second report page data reflecting the execution results; and
a report printing unit configured to, when said determination unit determines that the content of the first report page data and the execution results do not coincide with each other, print the second report page data, and when said determination unit determines that the content of the first report page data and the execution results coincide with each other, print the first report page data.

2. An image forming apparatus comprising:
an image data generating unit configured to generate image data for printing using job data on a print job;
a printing unit configured to carry out a printing process on the image data generated by said image data generating unit;
an obtaining unit configured to obtain execution results of the printing process carried out by said printing unit;
a report page data generating unit configured to, based on attributes set in the print job, generate report page data coinciding with the execution results obtained by said obtaining unit; and
a report printing unit configured to print the report page data generated by said report page data generating unit.

3. An image forming apparatus comprising:
an image data generating unit configured to generate image data for printing using job data on a print job;
a report page data generating unit configured to generate report page data before executing the print job based on attributes set in the print job;
a printing unit configured to carry out a printing process on the image data generated by said image data generating unit;
an obtaining unit configured to obtain execution results of the printing process carried out by said printing unit;
a determination unit configured to determine whether a content of the report page data generated by said report page data generating unit and the execution results obtained by said obtaining unit coincide with each other;
an alternative report page data obtaining unit configured to, when said determination unit determines that the content of the report page data and the execution results do not coincide with each other, obtain alternative report page data indicating that the content of the report page data and the execution results do not coincide with each other; and
a report printing unit configured to, when said determination unit determines that the content of the report page data and the execution results do not coincide with each other, print the alternative report page data, and when said determination unit determines that the content of the report page data and the execution results coincide with each other, print the report page data.

4. A control method for an image forming apparatus, comprising:
an image data generating step of generating image data for printing using job data on a print job;
a report page data generating step of generating first report page data before executing the print job based on attributes set in the print job;
a printing step of carrying out a printing process on the image data generated in said image data generating step;
an obtaining step of obtaining execution results of the printing process carried out in said printing step;
a determination step of determining whether a content of the first report page data and the execution results coincide with each other;
a report page data regenerating step of, when it is determined in said determination step that the content of the first report page data and the execution results do not coincide with each other, regenerating second report page data reflecting the execution results; and
a report printing step of, when it is determined in said determination step that the content of the first report page data and the execution results do not coincide with each other, printing the second report page data, and when it is determined in said determination step that the content of the first report page data and execution results coincide with each other, printing the first report page data.

5. A control method for an image forming apparatus, comprising:
an image data generating step of generating image data for printing using job data on a print job;
a printing step of carrying out a printing process on the image data generated in said image data generating step;
an obtaining step of obtaining execution results of the printing process carried out in said printing step;
a report page data generating step of, based on attributes set in the print job, generating report page data coinciding with the execution results obtained in said obtaining step; and
a report printing step of printing the report page data generated in said report page data generating unit.

6. A control method for an image forming apparatus, comprising:
an image data generating step of generating image data for printing using job data on a print job;
a report page data generating step of generating report page data before executing the print job based on attributes set in the print job;
a printing step of carrying out a printing process on the image data generated in said image data generating step;
an obtaining step of obtaining execution results of the printing process carried out in said printing step;
a determination step of determining whether a content of the report page data generated in said report page generating step and the execution results obtained in said obtaining step coincide with each other;
an alternative report page data obtaining step of, when said it is determined in said determination step that the content of the report page data and the execution results do not coincide with each other, obtaining alternative report page data indicating that the content of the report page data and the execution results do not coincide with each other; and
a report printing step of, when it is determined in said determination step that the content of the report page data and the execution results do not coincide with each other, printing the alternative report page data, and when it is determined in said determination step that the content of the report page data and the execution results coincide with each other, printing the report page data.

7. A non-transitory computer-readable storage medium storing a program for causing a computer to execute a control method for an image forming apparatus, the control method comprising:
an image data generating step of generating image data for printing using job data on a print job;
a report page data generating step of generating first report page data before executing the print job based on attributes set in the print job;
a printing step of carrying out a printing process on the image data generated in the image data generating step;
an obtaining step of obtaining execution results of the printing process carried out in the printing step;
a determination step of determining whether a content of the first report page data and the execution results coincide with each other;
a report page data regenerating step of, when it is determined in the determination step that the content of the first report page data and the execution results do not coincide with each other, regenerating second report page data reflecting the execution results; and
a report printing step of, when it is determined in the determination step that the content of the first report page data and the execution results do not coincide with each other, printing the second report page data, and when it is determined in the determination step that the content of the first report page data and the execution results coincide with each other, printing the first report page data.

8. A non-transitory computer-readable storage medium storing a program for causing a computer to execute a control method for an image forming apparatus, the control method comprising:
an image data generating step of generating image data for printing using job data on a print job;
a printing step of carrying out a printing process on the image data generated in the image data generating step;
an obtaining step of obtaining execution results of the printing process carried out in the printing step;
a report page data generating step of, based on attributes set in the print job, generating report page data coinciding with the execution results obtained in the obtaining step; and
a report printing step of printing the report page data generated in the report page data generating unit.

9. A non-transitory computer-readable storage medium storing a program for causing a computer to execute a control method for an image forming apparatus, the control method comprising:
an image data generating step of generating image data for printing using job data on a print job;
a report page data generating step of generating report page data before executing the print job based on attributes set in the print job;
a printing step of carrying out a printing process on the image data generated in the image data generating step;
an obtaining step of obtaining execution results of the printing process carried out in the printing step;
a determination step of determining whether a content of the report page data generated in said report page generating step and the execution results obtained in said obtaining step coincide with each other;
an alternative report page data obtaining step of, when the it is determined in the determination step that the content of the report page data and the execution results do not coincide with each other, obtaining alternative report page data indicating that the content of the report page data and the execution results do not coincide with each other; and
a report printing step of, when it is determined in the determination step that the content of the report page data and the execution results do not coincide with each other, printing the alternative report page data, and when it is determined in the determination step that the content of the report page data and the execution results coincide with each other, printing the report page data.
